(19) United States
(12) Patent Application Publication
(10) Pub. No.: US 2019/0227413 A1
(43) Pub. Date: Jul. 25, 2019

(54) Camera Mount System

(71) Applicant: Clark Hudson, Castle Pines, CO (US)

(72) Inventor: Clark Hudson, Castle Pines, CO (US)

(21) Appl. No.: 16/239,336

(22) Filed: Jan. 3, 2019

Related U.S. Application Data
(60) Provisional application No. 62/621,073, filed on Jan. 24, 2018.

(51) Int. Cl. G03B 17/56; F16M 13/02; A01K 29/00

(52) U.S. Cl. CPC G03B 17/561; A01K 29/005; F16M 13/022

(57) ABSTRACT

Embodiments of the invention are directed to a mounting system, device, and method used in the context of a fence. In certain embodiments, the mounting system is directed specifically for a chain-linked fence. It is an object of the embodiments of the present invention to provide a device for mounting a recording device to a fence. Certain embodiments of the invention include a mounting interface that attaches to a fence, and further supports the attachment to a recording device. Adjustment of the recording device relative to the mounting interface allows for the fine tuning and positioning of a recording device relative to an opening in the fence, in order to optimally position the lens of the recording device and prevent the fence from visually obstructing the lens of the recording device. Embodiments of the invention provide a mounting interface allowing a user to attach a recording device high on a fence for optimal perspective of the events to be recorded or photographed.

### CROSS-REFERENCE TO RELATED APPLICATIONS

The present invention claims priority to U.S. Provisional Patent Application Ser. No. 62/621,073 entitled “Camera Mount System” filed on Jan. 24, 2018, which is incorporated herein by reference.

### FIELD OF THE INVENTION

The present invention is related to mounting systems for video and still cameras.

### BACKGROUND OF THE INVENTION

Chain-linked fences provide a barrier between two areas to avert certain objects, people, and animals. For instance, chain-linked fences are common barriers used around sports fields (e.g. baseball fields). In certain cases, events, people, objects, animals, and other things of interest are placed on either side of chain-linked fence.

Filming, video recording, photographing, or otherwise visual and audio-recording through a chain-linked fence provides a challenge. The chain-linked fence, though providing protection, can also obstruct the visual field that may be recorded. Recorded footage that has a chain-linked fence at the forefront can be a distraction from the actual intended subject of the footage, where the intended subject is located beyond the chain-linked fence. Chain-linked fence can also interfere with the autofocus systems commonly found in video and still cameras.

### SUMMARY OF THE INVENTION

Embodiments of the invention are directed to a mount system, device, and method used in the context of a fencing. In certain embodiments, the mount is directed specifically for a chain-linked fence. It is the object of the embodiments of the present invention to provide a mounting interface for a recording device to a fence. Certain embodiments of the invention include a mounting interface that attaches to a fence, and further supports the attachment to a recording device. A camera mounted on the mounting interface records events through a chain-linked fence without the visual obstruction of the lens that may be caused by the fence. Embodiments of the invention provide a mounting interface allowing a user to attach a recording device on a fence.

Certain embodiments of the invention include a hooking element to attach the mounting device to the fence. A hooking element includes a first portion and a second portion, where the first portion is attached to a body, and a second portion hooks onto a fence. A counterweight located below the mounting device allows a user to handle the mounting device. A counterweight stabilizes the mounting device when the mounting device is attached or hooked onto the fence. In certain embodiments, a counterweight is telescopically extendable. An extendable counterweight allows a user to place the mounting device up high on a fence.

The mounting device further includes a body having a base portion and a side portion. A bracket is attached to the side portion of the body. A bracket includes a horizontal portion and a vertical portion, where the vertical portion attaches to the body, and the horizontal portion attaches to a recording device. Various parts of the mounting device are adjustable. Adjustment in a horizontal direction and vertical direction allows for the fine tuning and positioning of a recording device relative to the mounting device. The adjustment of the recording device in the horizontal and vertical directions also allows for the adjustment relative to the chain-linked fence, in order to optimally position the recording device (e.g. to prevent obstruction of the field of view by the chain-linked fence).

These and other advantages will be apparent from the disclosure of the inventions contained herein. The above-described embodiments, objectives, and configurations are neither complete nor exhaustive. As will be appreciated, other embodiments of the invention are possible using, alone or in combination, one or more of the features set forth above or described in detail below. Further, this Summary is neither intended nor should it be construed as being representative of the full extent and scope of the present invention. The present invention is set forth in various levels of detail in this Summary, as well as in the attached drawings and the detailed description below, and no limitation as to the scope of the present invention is intended to either the inclusion or non-inclusion of elements, components, etc. in this Summary. Additional aspects of the present invention will become more readily apparent from the detailed description, particularly when taken together with the drawings, and the claims provided herein.

### DESCRIPTION OF THE FIGURES

FIG. 1: A view of the mounting device in certain embodiments.

FIG. 2: A view of the mounting device in certain embodiments.

FIG. 3A: A top view of a hooking element found in certain embodiments.

FIG. 3B: A side view of a hooking element found in certain embodiments.

FIG. 3C: A perspective view of a hooking element found in certain embodiments.

FIG. 4: A perspective view of a bracket and body found in certain embodiments.

FIG. 5: A tightening element found in certain embodiments.

FIG. 6: A tightening element found in certain embodiments.

FIG. 7: An example of a mounting device attached to a fence in certain embodiments.

FIG. 8: An example of a mounting device attached to a fence in certain embodiments.

FIG. 9: A perspective view of a hooking element in certain embodiments.

FIG. 10: A side view of a hooking element in certain embodiments.

### DETAILED DESCRIPTION

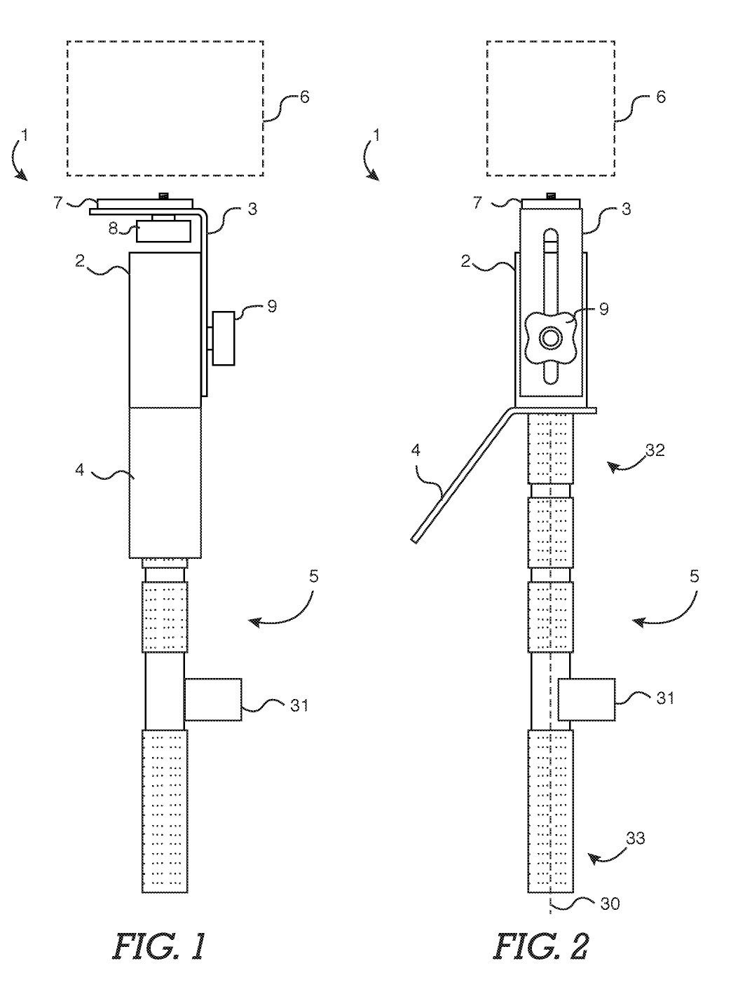

The present disclosure can provide a number of advantages depending on the particular aspect, embodiment, and/or configuration. Certain embodiments of the invention are directed to a mount system, device, and method used in the context of a fence. In an embodiment, a mounting device 1 as seen in FIG. 1-2 are described.

A mounting device 1 supports a recording device 6 on a chain-linked fence. It will be appreciated that a recording device 6 includes, but is not limited to, cameras, camcorders, smartphones, microphones, accessories or adaptors for mounting a smartphone or other electronic device, and the like. In certain embodiments, the mounting device supports a GoPro™ device, or other handheld cameras. Attachment of the recording device to the mounting device 1 can be accomplished, for example, using a standard ¼″-20 screw known to those skilled in the art. In certain embodiments, additional smartphone adapters for holding a smartphone may be attached to the mounting device.

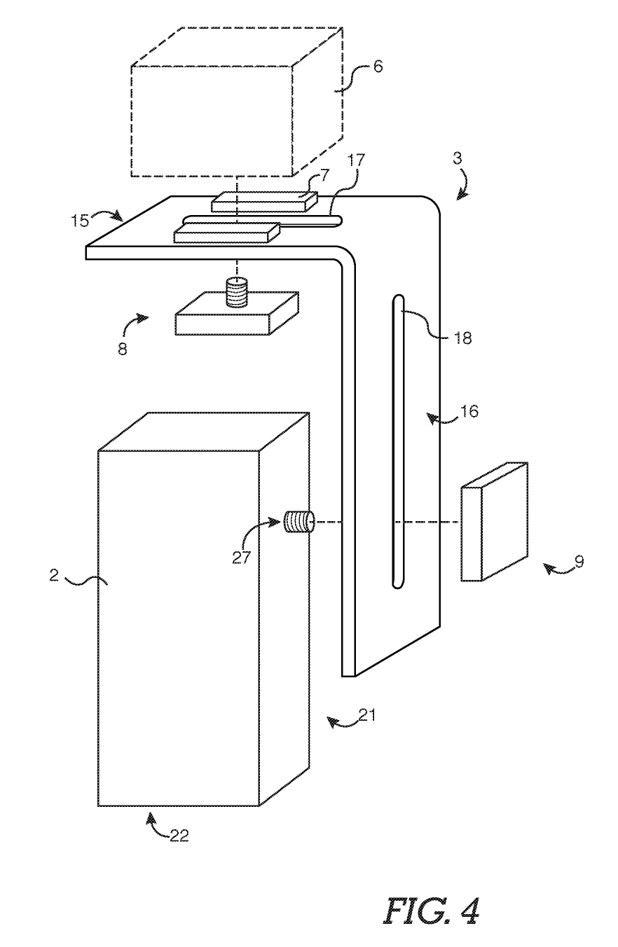

In certain embodiments, a bracket has a horizontal and a vertical portion. Referring to FIGS. 1, 2, and 4, the bracket includes an L-shaped form, further defining a horizontal portion and vertical portion. Referring to FIG. 4, the horizontal portion 15 of the bracket 3 includes a first slot 17. The recording device 6 is attached to the horizontal portion 15. Referring to exemplary drawings FIGS. 1, 2, and 4, padding 7 is located on the horizontal portion to provide a soft support for the recording device. Padding includes, for example, rubber, cork, foams, gels, and other materials that support a recording device while preventing damage to the device.

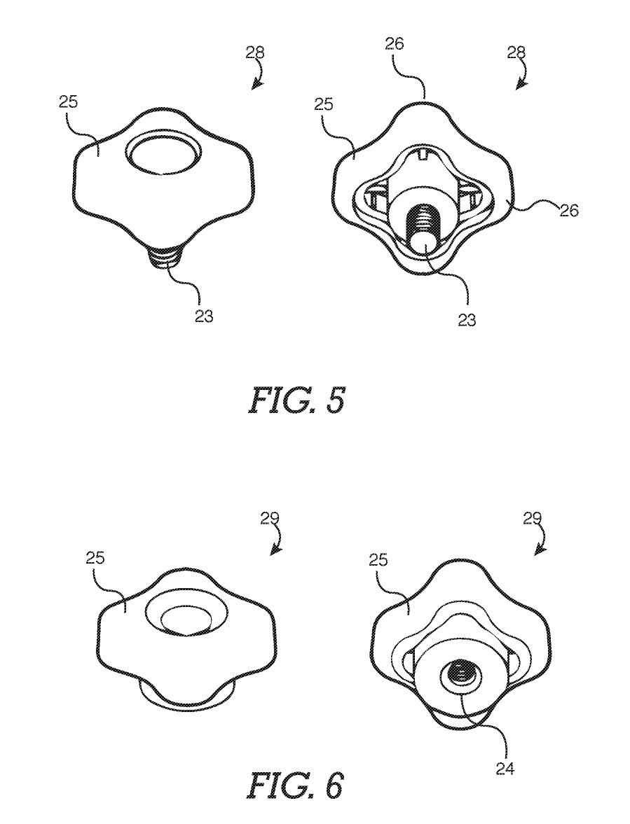

The recording device 6 is secured to the bracket 15 using a tightening element 8. The tightening element 8 attaches to a recording device 6. In some cases, the tightening element 8 attaches to an adapter, where the adapter further attaches to a recording device. The tightening element 8 can be moved in a generally horizontal direction relative to the first slot 17, allowing adjustment of the recording device in a generally horizontal direction. In certain embodiments, the tightening element 8 can be rotated within the first slot 17, allowing the recording device to be attached at an angle relative to the direction of the first slot 17. In certain embodiments, a tightening element, such as knob 28 (seen in FIGS. 4-5) includes a thread 23 located on one side of the knob. In certain embodiments, the thread includes a standard ¼″-20 screw, although other embodiments will contemplate other sized screws.

Referring to an exemplary diagram in FIG. 5, a tightening element includes a knob 8 having a male thread 23 and a handle 25. A handle portion 25 includes at least one protrusion 26. In certain embodiments, the handle includes at least one protrusion, at least two protrusions, at least three protrusions, at least four protrusions, or at least five protrusions. A first tightening knob can be used to secure a recording device to the mounting device.

The vertical portion 16 of the bracket 3 includes a second slot 18. Referring to FIG. 4, the vertical portion 16 is adjustably connected to the body 2 side portion 21. In certain embodiments, a body 2 has a side portion 21 and a base portion 22, as seen in FIG. 4. The bracket 3 can be moved vertically relative to the body 2. The bracket 3 may be tightened to the body 2 using a tightening element 9. In certain embodiments, the bracket 3 can be rotated about tightening element 9, allowing bracket 3 to be oriented at an angle relative to the body 2. As seen in FIGS. 4 and 6, a second tightening knob 29 includes a female thread 24 and a handle 25. Referring to FIG. 4, a tightening element may be used to secure a bracket 3 to a body 2 by tightening around the thread 27, where the thread 27 may be located on the side portion of a body.

It will be appreciated that adjustment of the bracket in a horizontal direction and vertical direction allows for the fine tuning and positioning of a recording device relative to the mounting device. The adjustment of the recording device in the horizontal and vertical directions also allows for the adjustment relative to the chain-linked fence, in order to optimally position the lens and focusing elements of a recording device (e.g. to prevent obstruction of the field of view by the chain-linked fence).

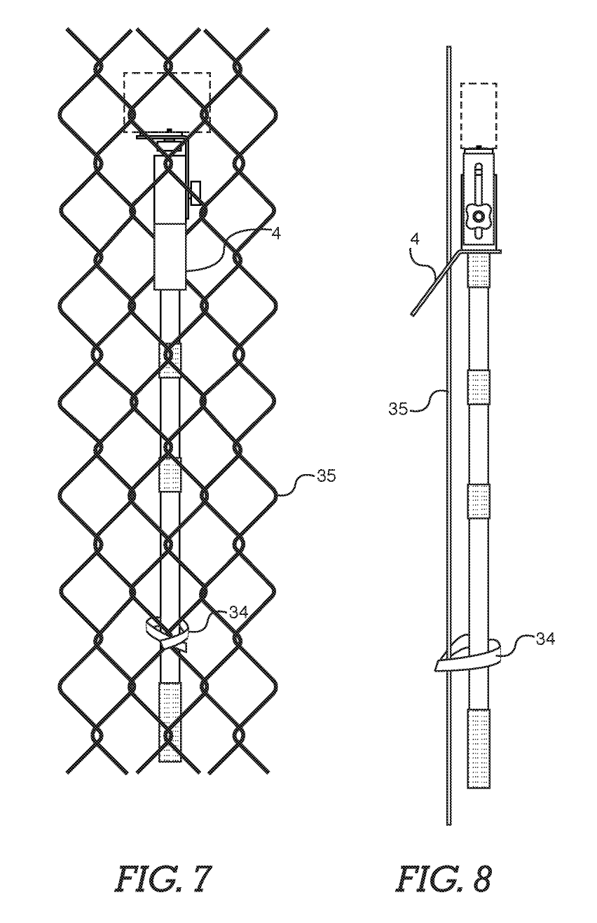

A body 2 includes a base portion 22. A base portion 22 is connected to the counterweight 5. The counterweight 5 includes a first end 32 and a second end 33. In certain embodiments, a counterweight 5 first end is rotatably connected to the base portion 22. The counterweight includes a telescopic, extendable rod. The second end 33 is extendable relative to the first end 32 in a direction along its longitudinal axis 30. Provided at the counterweight 5 second end 33 is a securement element 31. It will be appreciated that the securement element includes mechanical features to help secure the counterweight second end to the fence. As seen in FIGS. 7 and 8, these features 34 include, for example, but are not limited to, straps having a hook and loop, straps having a buckle, or straps having a magnetic closure. The features 34 may be used to secure the counterweight to a fence 35. A strap, for example, provides a way to secure the counterweight portion of the mounting device on the fence. It will also be appreciated that the securement element 31 includes, for example, a bungee cord that further attaches to the fence, allowing the second end of the counterweight to be further secured. In another embodiment, a securement element 31 includes, for example, a bag to add additional counterweight, a hook for hooking to the fence or another object, or a strap to attach to an additional counterweight. The additional counterweight can include, for example, a rock, water bottle or bladder, or other weighted material that biases the second end of the counterweight 5 in a vertical downwards direction.

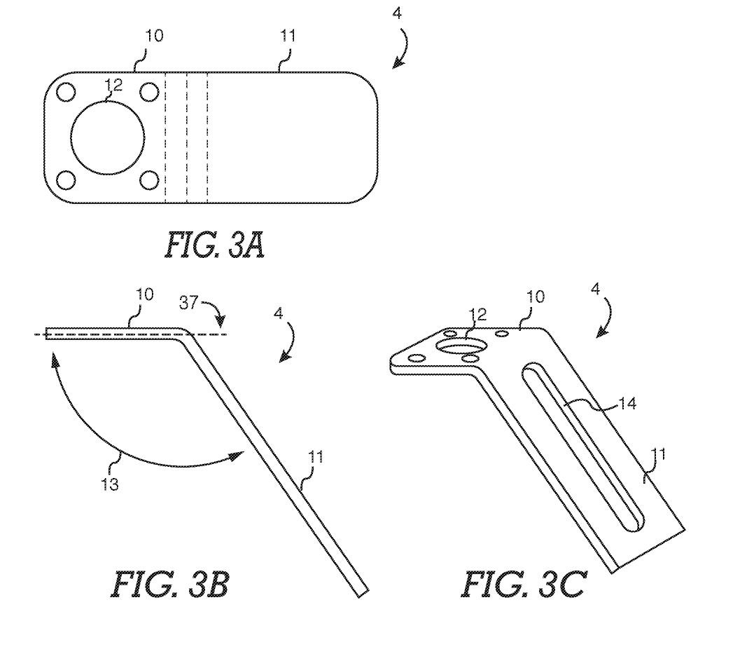

The body 2 is further connected to a hooking element 4. The hooking element may be located on any area of the body 2. In certain embodiments, the hooking element is connected to the base portion. In certain embodiments, the hooking element is connected to the counterweight 5. In certain embodiments, the body includes an integrated hooking element. It will be appreciated that the hooking element is adapted to fit through an opening in a fence and hook onto a fence, allowing the mounting device to hang on the fence while preventing the mounting device from sliding around or moving. The hooking element includes at least a first portion. As seen in FIGS. 1, 2, 3A, 3B, and 3C, a hooking element 4 includes a first portion 11 adapted for hanging on a fence, and a second portion 10 that connects to the body. In certain embodiments, the hooking element first portion is substantially flat. It will be appreciated that the first portion can have a cross-section of any suitable shape for resting in the V-shaped bottom of a chain-linked fence opening, for example, round, oval, square, rectangular, or triangular. As seen in FIG. 3B, in one embodiment, the first portion 11 is disposed relative a plane 37 at an angle 13 of about 115°. It will be appreciated that the angle 13 can include other angles. For example, in another embodiment, the angle 13 is about 94° to 114°. In another embodiment, the angle 13 is about 116° to 125°. In another embodiment, the angle 13 is about 126° to 135°. In another embodiment, the angle 13 is about 136° to 145°. In another embodiment, the angle 13 is about 146° to 155°. In another embodiment, the angle 13 is about 156° to 165°. In another embodiment, the angle 13 is about 166° to 175°. It will be appreciated that the angle of the first portion 11 may be measured relative to the longitudinal axis 30 of the counterweight which is disposed at about 90° to plane 37. For example, in one embodiment, the first portion 11 is disposed relative to longitudinal axis 30 at an angle of about 25°. A hooking element first portion may further include an opening 14. In certain embodiments, the mounting device includes a single hooking element. In another embodiment, the mounting device may include two hooking elements spaced apart and adapted to rest on the bottoms of two adjacent chain-linked fence openings.

In one embodiment, the hooking element second portion is substantially flat. In certain embodiments, the hooking element second portion includes a first opening 12. The second portion allows, for example, the hooking element to be fitted over the counterweight 5 where the counterweight and body 2 attach.

As shown in FIG. 7, the fence may be a chain-link fence (also referred to as wire netting, wire-mesh fence, chain-wire fence, cyclone fence, hurricane fence, or diamond-mesh fence). Chain-link fence is a type of woven fence usually made from galvanized or LLDPE-coated steel wire. The wires run vertically and are bent into a zig-zag pattern so that each “zig” hooks with the wire immediately on one side and each “zag” with the wire immediately on the other. This forms the characteristic diagonal squares or diamond pattern seen in this type of fence as shown in FIG. 7. The mesh of chain-link fence is typically measured diagonally in both directions using inside dimensions. The most common mesh sizes for chain link fence are 2″, 2¼″, and 2⅜″.

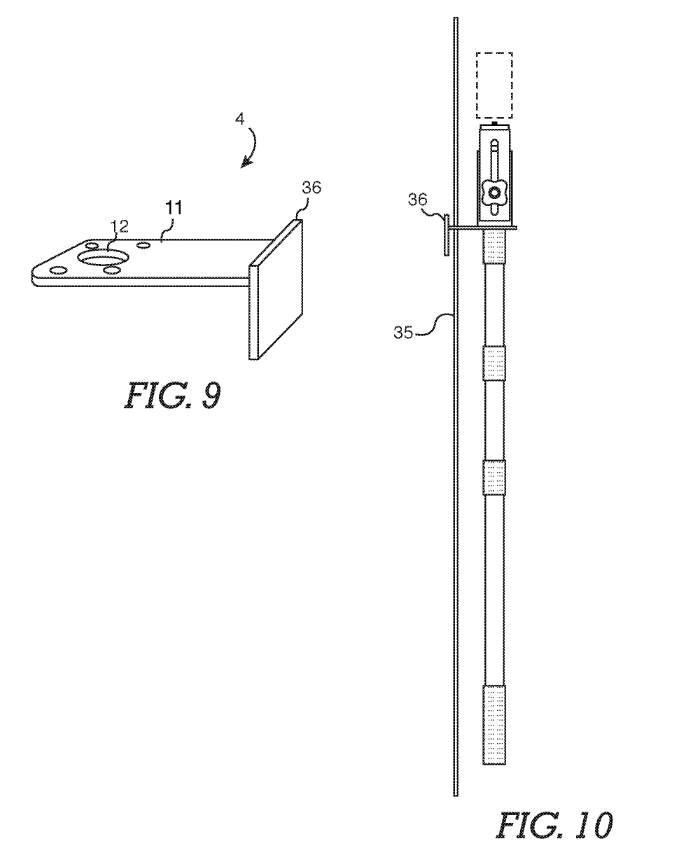

In another exemplary embodiment, a hooking element includes a first portion 11 and a hook end 36 as seen in FIG. 9. The first portion can have a cross-section of any suitable shape for resting in the V-shaped bottom of a chain linked fence opening, for example, round, oval, square, rectangular, or triangular. Similarly, the hook end 36 may be of any suitable shape and size that will fit through a chain linked fence opening, for example, a square as shown in FIG. 9, or a rectangle, circle, oval, or triangle. The first portion 11 rests on a fence and the hook end 36 prevents the first portion from slipping out of the opening, as seen in FIG. 10. For example, as shown in FIG. 9, the hook end 36 is a square that is sized approximately 1½″ by 1½″. Thus in order to fit through a 2″ opening in a chain linked fence, the mounting device must be rotated so that the hook end 36 is about 40° to 45° from vertical. Once the hook end 36 is placed through the opening, the mounting device is rotated back to vertical, thereby orienting the hook end 36 in a position that will not pass through the fence opening. Hence, it will be appreciated that a hooking element with first portion 11 and hook end 36, may be used to secure the mounting device on the fence so that it will not be unintentionally dislodged.

It will be appreciated that the apparatus and features described herein may be made of metallic, polymeric, plastic, inorganic, synthetic, and natural materials. These materials include, but are not limited to metals and alloys, such as steel, stainless steel, galvanized metals, copper, copper alloys, nickel, nickel alloys, iron, iron alloys thereof, combinations thereof, and/or other equivalent materials. In certain embodiments, the mounting device may also be made of plastic materials, including but not limited to, PVC and HDPE.

While various embodiments of the present invention have been described in detail, it is apparent that modifications and alterations of those embodiments will occur to those skilled in the art. However, it is to be expressly understood that such modifications and alterations are within the scope and spirit of the present invention. Further, the inventions described herein are capable of other embodiments and of being practiced or of being carried out in various ways. In addition, it is to be understood that phraseology and terminology used herein is for the purposes of description and should not be regarded as limiting, The use of “including,” “comprising,” or “adding” and variations thereof herein are meant to encompass the items listed thereafter and equivalents thereof, as well as, additional items.

I claim:

1. A device for mounting a recording device on a fence having multiple openings, comprising:
a body, the body comprising a base portion and a side portion;
a bracket having a horizontal portion and a vertical portion, the vertical portion adjustably interconnected to the body side portion, the horizontal portion adapted to adjustably connect to a recording device;
a hooking element interconnected to the body base portion, the hooking element comprising a first portion extending in a direction away from the body, and adapted to pass through an opening in the fence;
a counterweight including a first end and a second end, the first end interconnected to the body base portion.

2. The mounting device of claim 1, wherein the hooking element first portion is substantially flat.

3. The mounting device of claim 3, wherein the hooking element first portion is disposed relative to a horizontal plane at an angle of about 115°.

4. The mounting device of claim 1, wherein the counterweight comprises a hook interconnected to the second end.

5. The mounting device of claim 1, wherein the counterweight further comprises a securement element proximate to the second end.

6. The mounting device of claim 5, wherein the securement element comprises a strap.

7. The mounting device of claim 6, wherein the strap further comprises hook and loop material.

8. The mounting device of claim 1, wherein the counterweight further defines a longitudinal axis, and wherein the counterweight first end is telescopically extendable relative to the counterweight second end.

9. The mounting device of claim 1, wherein the bracket horizontal portion further comprises a first tightening element, wherein the first tightening element comprises a thread and a handle.

10. The mounting device of claim 9, wherein the bracket horizontal portion further comprises a first slot, and the first tightening element is movable within the first slot.

11. The mounting device of claim 1, wherein the bracket vertical portion further comprises a second tightening element, wherein the second tightening element comprises a thread and a handle.

12. The mounting device of claim 11, wherein the bracket vertical portion further comprises a second slot, and the second tightening element is movable within the second slot.

13. The mounting device of claim 1, consisting of a single hooking element.

14. A device for mounting a recording device on a chain-linked fence, comprising:
a body, the body defining a base portion and a side portion;
a bracket having a horizontal portion and a vertical portion, the bracket horizontal portion further comprising a first slot, and a first tightening element, wherein the first tightening element is movable within the first slot, and the first tightening element is connectable to a recording device;
the bracket vertical portion further comprising a second slot, and a second tightening element, wherein the second tightening element is movable within the second slot, and the second tightening element is interconnected with the body side portion;
a hooking element interconnected to the body base portion, the hooking element comprising a first portion extending in a direction away from the body and adapted to hook on an opening in the fence;
a telescopic counterweight with a first end and a second end, wherein the first end is interconnected to the body base portion.

15. The mounting device in claim 14, wherein the counterweight is rotatably interconnected to the base portion.

16. The mounting device in claim 14, wherein the counterweight further comprises a securement element proximate to the second end.

17. The mounting device in claim 16, wherein the securement element comprises a hook and loop strap.

18. The mounting device in claim 14, wherein the hooking element further comprises a hook end adapted to pass through an opening in the fence.

19. A device for mounting a recording device on a chain-linked fence, comprising:
a body, the body defining a base portion and a side portion;
a bracket having a horizontal portion and a vertical portion, the horizontal portion adapted to interconnect with a recording device, and the vertical portion interconnected with the body side portion;
a telescopic counterweight with a first end and a second end, the first end interconnected to the body base portion, and wherein the counterweight further defines a longitudinal axis; and
a hooking element interconnected to the mounting device, the hooking element comprising a first portion extending in a direction away from the device and adapted to pass through an opening in the fence.

20. The mounting device in claim 19, wherein the hooking element first portion is disposed relative to the longitudinal axis at an angle of about 25°.
